(19) United States
(12) Patent Application Publication
(10) Pub. No.: US 2008/0058033 A1
(43) Pub. Date: Mar. 6, 2008

(54) PORTABLE ELECTRONIC DEVICE

(75) Inventor: Anders Angelhag, Lund (SE)

Correspondence Address: HARRITY SNYDER, L.L.P., 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 11/533,937

(22) Filed: Sep. 21, 2006

Related U.S. Application Data
(60) Provisional application No. 60/824,707, filed on Sep. 6, 2006.

(51) Int. Cl. H04M 1/00

(52) U.S. Cl. 455/575.1

(57) ABSTRACT

A portable electronic device includes a front side and a back side. The front side includes a display. The back side includes at least one key. A function of the at least one key is displayed in the display of the front side of the portable electronic device.

### RELATED APPLICATION

This application claims priority under 35 U.S.C. § 119 based on U.S. Provisional Application Ser. No. 60/824,707, filed Sep. 6, 2006, the disclosure of which is incorporated herein by reference.

### FIELD OF THE INVENTION

Implementations consistent with principles of the invention relate generally to portable electronic devices. In particular, implementations consistent with principles of the invention relate to a way of arranging the keys of portable electronic devices.

### BACKGROUND OF THE INVENTION

Market trends and technology capabilities show that imaging and multimedia usages will grow and hence users will desire bigger displays to view images, TV and videos in their portable electronic devices, such as mobile phones. Moreover, media and TV users may expect to be able to run the applications in landscape mode. For input of, for example, text, such as for Short Message Service (SMS) messages or telephone numbers, in the portable electronic devices, today's technologies provides touch screens, slider keyboards, or SoftWare (SW) keyboards that may be keyboards built on a combination of cursor and graphical User Interface (UI), where the cursor is used by the user to move through and select letters in a graphical keyboard shown on the display, such as, for example, PlayStation Portable (PSP) keyboards, or traditional keyboards on the front of the phone.

### SUMMARY OF THE INVENTION

According to a first aspect of the invention, a portable electronic device includes a front side that includes a display; and a back side that includes one or more keys, at least one of the keys being associated with a respective purpose, each respective key being located in a specific position on the back side of the portable electronic device, the purpose of the at least one key being displayed in a corresponding position in the display of the front side of the portable electronic device, activation of the at least one key causing the respective purpose to be performed.

Additionally, the front side includes one or more keys. The keys on the back side are adapted to be used by fingers of a user and the keys on the front side are adapted to be used by thumbs of the user.

Additionally, the purpose of the at least one key is adapted for inputting letters, signs, figures or commands.

Additionally, the purpose of the at least one key is adapted for navigation.

Additionally, the portable electronic device includes one border side pointing upwards and one border side pointing downwards when the portable electronic device is held parallel to a face of a user. The border side pointing upwards is longer than the border side pointing downwards.

Additionally, the portable electronic device includes two border sides pointing towards the sides when the portable electronic device is held parallel to the face of the user. The keys on the back side are positioned in one or more rows that are parallel to one or more of the border sides.

Additionally, the purpose of at least one other key on the back side is not displayed on the display.

Additionally, the purpose of at least one other key changes when the at least one key is depressed.

Additionally, the portable electronic device includes a mobile phone.

In a second aspect of the invention, a portable electronic device includes a front side that includes a display; and a back side that includes at least one key, a function of the at least one key being displayed in the display of the front side of the portable electronic device.

Additionally, the at least one key is associated with a plurality of functions.

Additionally, the back side includes at least eight keys.

Additionally, the function is displayed in a location in the display that corresponds to a location of the at least one key on the back side of the portable electronic device.

### BRIEF DESCRIPTION OF THE DRAWINGS

FIG. 1 is a schematic block diagram illustrating an embodiment of a portable electronic device seen from the front.

FIG. 2 is a schematic block diagram illustrating the embodiment depicted in FIG. 1 of the portable electronic device seen from behind.

FIG. 3 is a schematic block diagram illustrating another embodiment of a portable electronic device seen from the front.

FIG. 4 is a schematic block diagram illustrating the portable electronic device seen from above.

FIG. 5 is a schematic block diagram illustrating a further embodiment of the portable electronic device seen from behind.

FIG. 6 is a schematic block diagram illustrating the embodiment depicted in FIG. 5 of the portable electronic device seen from the front.

### DETAILED DESCRIPTION OF PREFERRED EMBODIMENTS

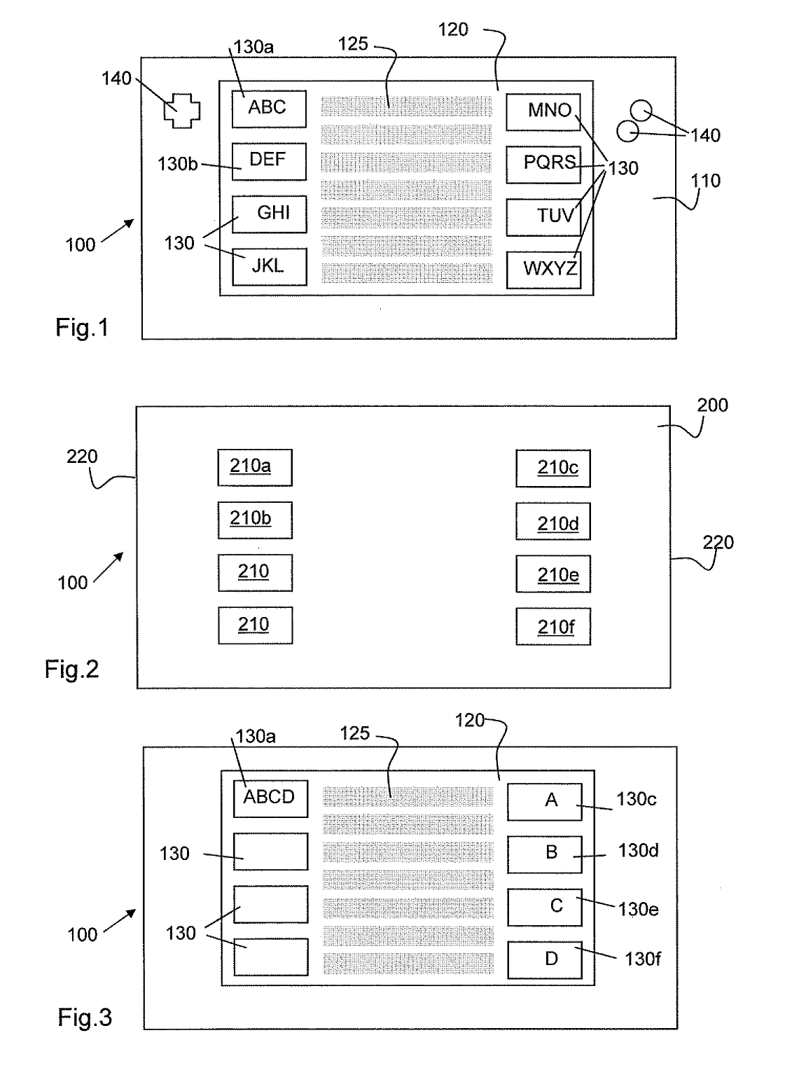

FIG. 1 shows an exemplary front view of portable electronic device 100. The portable electronic device 100 may be, for example, a mobile phone, a media phone, a TV phone, a gaming phone, a portable electronic device comprising a Media Browser accessory, or any other electronic device. As illustrated, portable electronic device 100 may include a front side 110 that includes a display 120. Display 120 may, for example, be intended for displaying media such as games, TV Video, pictures and/or different type of applications, such as text editors, email programs, internet browsers etc. Display 120 may consume a large portion of front side 110 since portable electronic device 100 may be small in size to meet the desires of the user of portable electronic device 100. Display 120 may further be intended for displaying text and FIG. 125, such as text during writing of an SMS, for displaying a received SMS, a telephone number, a menu etc., and/or other information commonly displayed in portable electronic devices.

FIG. 2 shows an exemplary rear view of portable electronic device 100. As illustrated, portable electronic device 100 comprises a back side 200. To provide a great deal of room for display 120, instead of placing all keys on the front side, back side 200 comprises one or more keys 210 (two of the keys 210 are referred to as 210a and 210b). Keys 210 on back side 200 may be used, for example, for inputting figures, such as telephone numbers, inputting letters or signs (such as, for example, Chinese signs) for writing SMS messages to be sent, to input commands, to select and navigate in menu systems, control games, or maneuver in a graphical user interface, and/or for other purposes Therefore, each of keys 210 has a specific purpose. For example, the purpose of key 210a may be for inputting the letters A, B and C and the purpose of key 210b may be for inputting the letters D, E and F. Alternatively or in addition, the purpose of key 201a may be for inputting a first predetermined figure and the purpose of key 210b may be for inputting a second predetermined figure. It will be appreciated that keys 210 may be associated with other purposes/functions.

In one implementation consistent with principles of the invention, each respective key 210 has a specific position on back side 200 of portable electronic device 100 and the purpose of each respective key 210 is displayed in a corresponding position in display 120 of front side 110 of portable electronic device 100. Display 120 may or may not be implemented as a touch screen. In one implementation, the displayed purpose 130 of the respective key 210 on back side 200 is shown in FIG. 1, where, for example, two of the displayed purposes 130 are referred to as 130a and 130b. For example, key 210a is positioned on back side 200 of portable electronic device 100 in a specific position and the purpose 130a of key 210a is displayed on the corresponding position in display 120 of front side 110, and key 210b is positioned on back side 200 of portable electronic device 100 in a specific position under key 210a, and the purpose 130b of key 210b is displayed on the corresponding position, i.e. under the purpose 130a in display 120 of front side 110. In this way, keys 210 on the back side 200 of portable electronic device 100 can be used by a user of portable electronic device 100, while portable electronic device 100 is still held in a position where front side 110 faces the face of the user. Each of the respective keys 210 may be positioned exactly behind the purpose of each of the corresponding purpose 130, but that is not necessary. It may be desirable to position the purposes 130 of the keys 210 in the same order in proportion to each other on display 120 as the order of the positions of keys 210 on back side 200.

In a mode where media is to be displayed on display 120, the purposes 130 of keys 210 may not be shown, providing as much room as possible available for the media. However, it may also be possible to display the purposes of the keys 130 also when the media is displayed. This is particularly advantageous if keys 120 on back side 200 are to be used during the media display. The purposes of keys 120 could be displayed or hidden when the user or an application within portable electronic device 100 prompts portable electronic device 100 to do so. By displaying the purpose of each key 120 on display 120, the purpose of each key 120 may easily be changed and optimized for different applications and different purposes within the same application. In one embodiment, for example, the purpose of one or more keys 210 may be displayed on display 120, one or more keys 210 may not have a purpose displayed on display 120, and/or one or more keys 210 may have a “static” purpose. A description of each key could be visualized on display 120 for non-experienced users or when shifting between alphabets, symbols or numbers. Front side 110 may also comprise one or more keys 140. In the example shown in FIG. 1, front side 110 comprises three keys 140.

According to another embodiment, also depicted in FIG. 2 and FIG. 3, when one of keys 210a of the back side is held down, the purposes 130 of the other keys 210 may be changed. In this way a small number of keys can be used for inputting wider alphabets. For example, assume the letters A, B, C and D are associated with key 120a, as illustrated in FIG. 3. When key 120a is pushed, the letters shown on the right hand keys may be changed, such that key 210c may be associated with the letter A, key 210d may be associated with the letter B, key 210e may be associated with the letter C, and key 210f may be associated with the letter D.

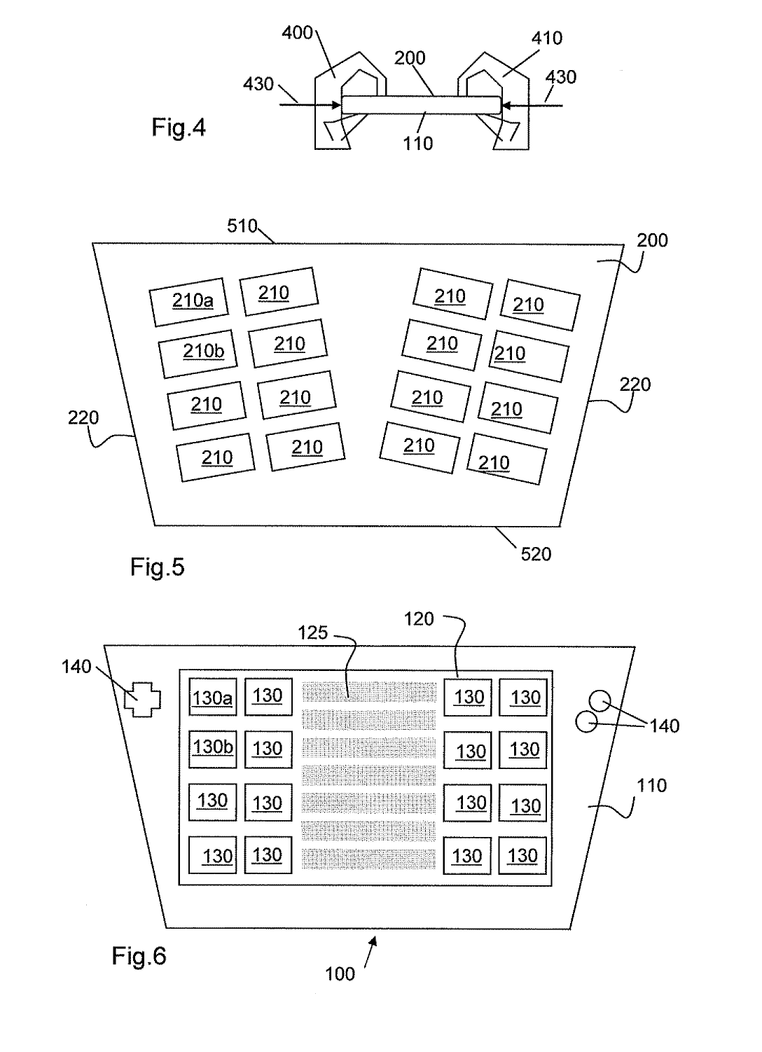

FIG. 4 shows portable electronic device 100 from a top perspective. As illustrated in FIG. 4, portable electronic device 100 may be held between the left hand 400 palm and the right hand 410 palm of the user with a soft pressure referred to as arrows 430. Keys 210 on back side 200 may be adapted to be used by the fingers of the user and keys 140 on front side 110 may adapted to be used by the thumbs of the user. This makes portable electronic device 100 easy to hold while typing, especially if the size of portable electronic device 100 is large (even though portable electronic device 100 may be kept as small as possible according to an implementation consistent with the principles of the invention). While eight keys 120 are shown in FIG. 2, more or fewer keys 120 may be provided in other implementations consistent with principles of the invention. For example, in the implementation depicted in FIG. 5, sixteen keys 120 are provided on back side 200 (two for each finger). It may also be fewer keys 120 such as one, two, three, etc. or more keys 120, up to as many as there are room for on back side 200.

Keys 120 may be positioned in a suitable way so as to be handled by the user. Keys 120 on back side 200 may be positioned at a place where the finger tips of the user's left hand 400 and where the finger tips of the user's right hand 410 are intended to be positioned when portable electronic device 100 is held by the user. Keys 120 on back side 200 may, for example, be positioned in rows as depicted in FIG. 2. Portable electronic device 100 comprises two border sides 220. The two border sides 220 are the two sides that are intended to be held by the left hand 400 and the right hand 410 of the user. Keys 210 on back side 200 may be positioned in rows or curves parallel to the border sides 220. In FIG. 5, an alternative embodiment is depicted in portable electronic device 100, as seen from the front. Furthermore, in FIG. 6, an alternative embodiment is depicted in portable electronic device 100, as seen from behind. These alternative embodiments may be used together as is depicted in FIGS. 5 and 6, but each of them may also be used separately. According to the first of the two alternative embodiments, keys 210 on back side 200 may be positioned in a plurality of rows, e.g. four rows, where two rows may be adapted for the left hand 400 fingers and two rows may be adapted for the right hand 410 fingers.

Portable electronic device 100 may comprises one border side 510 pointing upwards and one border side pointing downwards 520 when portable electronic device 100 is held parallel to the face of the user. According to the second alternative embodiment, the border side pointing upwards 510 is longer than the border side pointing downwards 520. This gives enough room for keys 140 on front side 110 at the same time as portable electronic device 100 can be kept small and light

Since each respective key has a specific position on the back side of the portable electronic device and the purpose of each respective key is displayed in a corresponding position in the display of the front side of the portable electronic device, the keys on the back side of the portable electronic device can be used, while the portable electronic device is still held in a position where the front side faces the face of the user. Since the keys are positioned on the back side the portable electronic device there is more room for the display on the front side.

### CONCLUSION

Implementations consistent with the principles of the invention may provide a key arrangement for a portable electronic device.

The foregoing description of preferred embodiments of the invention provides illustration and description, but is not intended to be exhaustive or to limit the invention to the precise form disclosed. Modifications and variations are possible in light of the above teachings or may be acquired from practice of the invention.

For example, while the description above focused on key arrangements for portable electronic devices, it will be appreciated that the techniques described herein may be equally applicable to other types of devices. Moreover, although the description above focused on key placement on a bottom surface of a portable electronic device, the keys may be placed in other locations (e.g., on side surfaces) in other implementations consistent with principles of the invention.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the principles of the invention is not limiting of the invention. Thus, the operation and behavior of the aspects were described without reference to the specific software code—it being understood that one of ordinary skill in the art would be able to design software and control hardware to implement the aspects based on the description herein.

Further, certain portions of the invention may be implemented as “logic” that performs one or more functions. This logic may include hardware, such as an application specific integrated circuit or a field programmable gate array, software, or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A portable electronic device comprising:
a front side comprising a display; and
a back side comprising one or more keys, at least one of the keys being associated with a respective purpose, each respective key being located in a specific position on the back side of the portable electronic device, the purpose of the at least one key being displayed in a corresponding position in the display of the front side of the portable electronic device, activation of the at least one key causing the respective purpose to be performed.

2. The portable electronic device according to claim 1, wherein the front side comprises one or more keys, the keys on the back side being adapted to be used by fingers of a user and the keys on the front side being adapted to be used by thumbs of the user.

3. The portable electronic device according to claim 1, wherein the purpose of the at least one key is adapted for inputting letters, signs, figures or commands.

4. The portable electronic device according to claim 1, wherein the purpose of the at least one key is adapted for navigation.

5. The portable electronic device according to claim 1, wherein the portable electronic device comprises one border side pointing upwards and one border side pointing downwards when the portable electronic device is held parallel to a face of a user, and wherein the border side pointing upwards is longer than the border side pointing downwards.

6. The portable electronic device according to claim 5, wherein the portable electronic device comprises two border sides pointing towards the sides when the portable electronic device is held parallel to the face of the user, and
wherein the keys on the back side are positioned in one or more rows that are parallel to one or more of the border sides.

7. The portable electronic device according to claim 1, wherein the purpose of at least one other key on the back side is not displayed on the display.

8. The portable electronic device according to claim 1, wherein the purpose of at least one other key changes when the at least one key is depressed.

9. The portable electronic device according to claim 1, wherein the portable electronic device includes a mobile phone.

10. A portable electronic device comprising:
a front side that includes a display; and
a back side that includes at least one key, a function of the at least one key being displayed in the display of the front side of the portable electronic device.

11. The portable electronic device of claim 10, wherein the at least one key is associated with a plurality of functions.

12. The portable electronic device of claim 10, wherein the back side include at least eight keys.

13. The portable electronic device of claim 10, wherein the function is displayed in a location in the display that corresponds to a location of the at least one key on the back side of the portable electronic device.
